(19) United States
(12) Patent Application Publication
(10) Pub. No.: US 2011/0154492 A1
(43) Pub. Date: Jun. 23, 2011

(54) MALICIOUS TRAFFIC ISOLATION SYSTEM AND METHOD USING BOTNET INFORMATION

(76) Inventors: Hyun Cheol Jeong, Seoul (KR); Chae Tae Im, Seoul (KR); Seung Goo Ji, Gyeonggi-do (KR); Joo Hyung Oh, Seoul (KR); Dong Wan Kang, Seoul (KR); Tae Jin Lee, Seoul (KR); Yong Geun Won, Seoul (KR)

(21) Appl. No.: 12/821,549

(22) Filed: Jun. 23, 2010

(30) Foreign Application Priority Data
Dec. 18, 2009 (KR) 10-2009-0126914

(51) Int. Cl. G06F 21/00

(52) U.S. Cl. 726/23

(57) ABSTRACT

The present invention relates to a malicious traffic isolation system and method using botnet information, and more particularly, to a malicious traffic isolation system and method using botnet information, in which traffics for a set of clients having the same destination are routed to the isolation system based on a destination IP/Port, and botnet traffics are isolated using botnet information based on similarity among groups of the routed and flowed in traffics. The present invention may provide a malicious traffic isolation method using botnet information, which can accommodate traffics received from a PC or a C&C server infected with a bot into a quarantine area, isolate traffics generated by normal users from traffics transmitted from malicious bots, and block the malicious traffics. In addition, the present invention may provide a malicious traffic isolation method using botnet information, which can provide a function of mitigating DDoS attacks of a botnet.

### CROSS-REFERENCE TO RELATED APPLICATIONS

This application claims the benefit of Korean Patent Application No. 10-2009-0126914, filed on Dec. 18, 2009 in the Korean Intellectual Property Office, which is incorporated herein by reference in its entirety.

### BACKGROUND OF THE INVENTION

(a) Field of the Invention

The present invention relates to a malicious traffic isolation system and method using botnet information, and more particularly, to a malicious traffic isolation system and method using botnet information, in which traffics for a set of clients having the same destination are routed to the isolation system based on a destination IP/Port, and botnet traffics are isolated using botnet information based on similarity among groups of the routed and introduced traffics.

(b) Background of the Related Art

Bot is the abbreviation of a robot, which refers to a personal computer (PC) infected with software having a malicious intention. Botnet refers to a network of interconnected computers which are infected with such a bot. The botnet is remotely controlled by a bot master and is used for a variety of malicious behaviors, such as a DDoS attack, personal information collection, phishing, distribution of malicious codes, sending spam mails, and the like. Such a botnet can be classified based on a protocol used by the botnet.

Attacks using such a botnet are continuously increasing, and methods of the attacks are gradually diversified. Unlike the case of inducing Internet service failure through DDoS, there are bots that induce personal system failure or illegally acquire personal information. In addition, increasing are the cases of abusing the bots for cyber crimes by illegally leaking user information such as identification (ID), password, financial information, and the like. Furthermore, conventional hacking attacks are merely in the level of boasting or competing abilities of hackers through a community, while hacking attacks using a botnet follows a trend toward intensive use of the botnet by hacker groups and cooperation between the hacker groups to make monetary profits.

However, botnets are further ingeniously designed so as not to be easily detected or evaded through cutting-edge technologies such as periodical updates, run-time packing techniques, code self-modifications, encryption of command channels, and the like. In addition, there occur several thousands of kinds of botnet variations since sources of botnets are open to the public, and bot codes can be easily created or controlled through a user interface. Therefore, the problem is serious since even a person lacking of special knowledge or techniques can create and use a botnet. Bot zombies configuring such a botnet are distributed in Internet service providers' networks across the world irrespective of countries, and bot Command and Control (C&C) that controls the bot zombies can migrate to another network.

Therefore, many researches on the botnets are actively in progress based on recognition of seriousness of the botnet-related problems. However, it is difficult to grasp overall configuration and distribution of botnets by detecting only the botnets residing in a specific Internet service provider's network, and there are numerous variations of botnets or the like. Therefore, there is an urgent need to develop a method of easily detecting botnets.

### SUMMARY OF THE INVENTION

Accordingly, the present invention has been made to solve the above-mentioned problems occurring in the prior art, and it is an object of the present invention to provide a malicious traffic isolation system and method using botnet information, which can effectively isolate botnet traffics.

To accomplish the above object, in one aspect, the present invention provides a malicious traffic isolation system including: a botnet detection system for collecting traffics in a network and detecting a botnet; and a botnet isolation system for isolating traffics of the botnet.

The botnet isolation system includes: an isolation system manager for transmitting botnet group information including a protect target list, a zombie IP and C&C IP list; an isolation system agent for isolating a botnet group based on the botnet group information transmitted from the isolation system manager; and an isolation system monitor for monitoring the botnet isolation system in real-time.

The isolation system agent includes: an isolation system agent transmit and receive unit for receiving the protect target list, the zombie IP and C&C IP list from the isolation system manager and transmitting suspicious traffics and information on blockage of the suspicious traffics; a BGP unit for receiving traffics from the isolation system agent transmit and receive unit; an IP table unit for controlling filtering of traffics flowing in from the BGP unit; and a suspicious botnet storage unit for temporarily storing the suspicious traffics and transmitting the suspicious traffics to the isolation system agent transmit and receive unit.

To accomplish the above object, in another aspect, the present invention provides a malicious traffic isolation method including the steps of: detecting a botnet in a network; and isolating traffics of the botnet.

The malicious traffic isolation method further includes the steps of: after the step of detecting a botnet in a network, finding a malicious behavior of the detected botnet; and receiving existence of the malicious behavior, routing malicious traffics, and setting routing information to examine the malicious traffics.

Also, according to the malicious traffic isolation method, the step of isolating traffics of the botnet includes the steps of: isolating traffics of a botnet group flowing from outside to inside of a network in which the botnet is desired to be detected; or isolating traffics of a botnet group flowing from inside to outside of a network in which the botnet is desired to be detected.

In addition, according to the malicious traffic isolation method, the step of isolating traffics of a botnet group flowing from outside to inside of a network in which the botnet is desired to be detected includes the steps of: performing a first filtering by isolating DDoS traffics starting from a zombie IP among traffics headed for a safety zone from communication traffics starting from a C&C IP; performing a second filtering by secondarily determining the DDoS traffics by verifying a botnet IP and similarity using L2/L3/L4 information, the number of packets flowing in per unit time PPS, the number of bandwidths per unit time BPS, and the payload size in order to cope with the botnet traffics; and if a large amount of traffics flow in from outside to inside of the network after the first and second filtering steps are performed, performing a third filtering by applying rate-limit.

Further, according to the malicious traffic isolation method, in the step of performing the first filtering, communication traffics starting from the zombie IP among the traffics headed for the C&C IP is isolated from traffics starting from an unknown IP.

Moreover, according to the malicious traffic isolation method, the step of isolating traffics of a botnet group flowing from inside to outside of a network in which the botnet is desired to be detected includes the steps of: performing a first filtering by isolating communication traffics headed for a C&C IP, wherein the traffics are dropped if a SRC IP is a known zombie IP, and isolating communication traffics headed for the zombie IP; and if the SRC IP is an unknown IP in the communication traffics headed for the C&C IP or communication traffics headed for the zombie IP in the step of performing a first filtering, obtaining information on a new botnet using L2/L3/L4 information, the number of packets flowing in per unit time PPS, the number of bandwidths per unit time BPS, and the payload size of a corresponding traffic, obtaining the SRC IP as a zombie IP or the SRC IP as a C&C IP, and isolating the traffics or notifying the obtained information to a manager so as to cope with the malicious traffics.

### BRIEF DESCRIPTION OF THE DRAWINGS

The above and other objects, features and advantages of the present invention will be apparent from the following detailed description of the preferred embodiments of the invention in conjunction with the accompanying drawings, in which:

FIG. 1 is a block diagram conceptually showing a malicious traffic isolation system using botnet information according to the present invention;

FIG. 2 is a conceptual view showing connections needed for operating the malicious traffic isolation system according to the present invention;

FIG. 3 is a view showing the configuration of the malicious traffic isolation system using botnet information according to the present invention;

FIG. 4 is a conceptual view showing a botnet traffic collecting sensor of the malicious traffic isolation system using botnet information according to the present invention;

FIG. 5 is a view showing the configuration of a traffic information collecting module of the malicious traffic isolation system using botnet information according to the present invention;

FIG. 6 is a view showing the configuration of a traffic information management module of the malicious traffic isolation system using botnet information according to the present invention;

FIG. 7 is a view showing the configuration of a management communication module of the malicious traffic isolation system using botnet information according to the present invention;

FIG. 8 is a view showing the configuration of a sensor policy management module of the malicious traffic isolation system using botnet information according to the present invention;

FIG. 9 is a view showing the configuration of a botnet detection system of the malicious traffic isolation system using botnet information according to the present invention;

FIG. 10 is a view showing the structure of the botnet detection system of the malicious traffic isolation system using botnet information according to the present invention;

FIG. 11 is a view showing the configuration of a botnet group analyzer of the malicious traffic isolation system using botnet information according to the present invention;

FIG. 12 is a flowchart illustrating the operation of the botnet group analyzer of the malicious traffic isolation system using botnet information according to the present invention;

FIG. 13 is a flowchart illustrating the operation of a group information management module of the malicious traffic isolation system using botnet information according to the present invention;

FIG. 14 is a flowchart illustrating the operation of a group data management module of the malicious traffic isolation system using botnet information according to the present invention;

FIG. 15 is a flowchart illustrating the operation of a group matrix management module of the malicious traffic isolation system using botnet information according to the present invention;

FIG. 16 is a flowchart illustrating the operation of a suspicious group selection module of the malicious traffic isolation system using botnet information according to the present invention;

FIG. 17 is a flowchart illustrating the operation of a suspicious group comparison and analysis module of the malicious traffic isolation system using botnet information according to the present invention;

FIG. 18 is a view showing the configuration of a botnet organization analyzer of the malicious traffic isolation system using botnet information according to the present invention;

FIG. 19 is a flowchart illustrating the operation of the botnet organization analyzer of the malicious traffic isolation system using botnet information according to the present invention;

FIG. 20 is a sequence diagram showing overall signaling between an isolation system manager and an isolation system agent of the malicious traffic isolation system using botnet information according to the present invention;

FIG. 21 is a sequence diagram showing the operation among detailed modules of the botnet isolation system in the malicious traffic isolation system using botnet information according to the present invention;

FIG. 22 is a flowchart illustrating a malicious traffic isolation method using botnet information according to the present invention;

FIG. 23 is a conceptual view showing a botnet isolation system technology applied to traffics flowing from outside to inside of a network, in the malicious traffic isolation method using botnet information according to the present invention;

FIG. 24 is a block diagram showing a counter-attack algorithm applied to flowing-in traffics based on an internal C&C IP of a network, in the malicious traffic isolation method using botnet information according to the present invention;

FIG. 25 is a block diagram showing a counter-attack algorithm applied when a safety zone within a network is determined as a traffic flow-in target, in the malicious traffic isolation method using botnet information according to the present invention;

FIG. 26 is a block diagram showing a second and third filtering algorithm applied when traffics flowing from outside to inside of a network are isolated, in the malicious traffic isolation method using botnet information according to the present invention;

FIG. 27 is a conceptual view showing a botnet isolation system technology applied to traffics flowing from inside to outside of a network, in the malicious traffic isolation method using botnet information according to the present invention;

FIG. 28 is a block diagram showing a counter-attack algorithm applied when an external C&C IP is a target of traffic flowing out of a network in the case where traffics flowing from inside to outside of the network are isolated, in the malicious traffic isolation method using botnet information according to the present invention; and

FIG. 29 is a block diagram showing a counter-attack algorithm applied when a zombie IP is determined as a target of traffic flowing out of a network in the case where traffics flowing from inside to outside of the network are isolated, in the malicious traffic isolation method using botnet information according to the present invention.

### DETAILED DESCRIPTION OF THE PREFERRED EMBODIMENT

The preferred embodiments of the invention will be hereafter described in detail with reference to the accompanying drawings.

However, the present invention is not limited to embodiments which will be described below, but may be implemented in a variety of different forms. These embodiments are provided to render the disclosure of the present invention complete and allow those skilled in the art to fully understand the scope of the present invention. In the following description, elements having the same function are denoted by the same reference numerals.

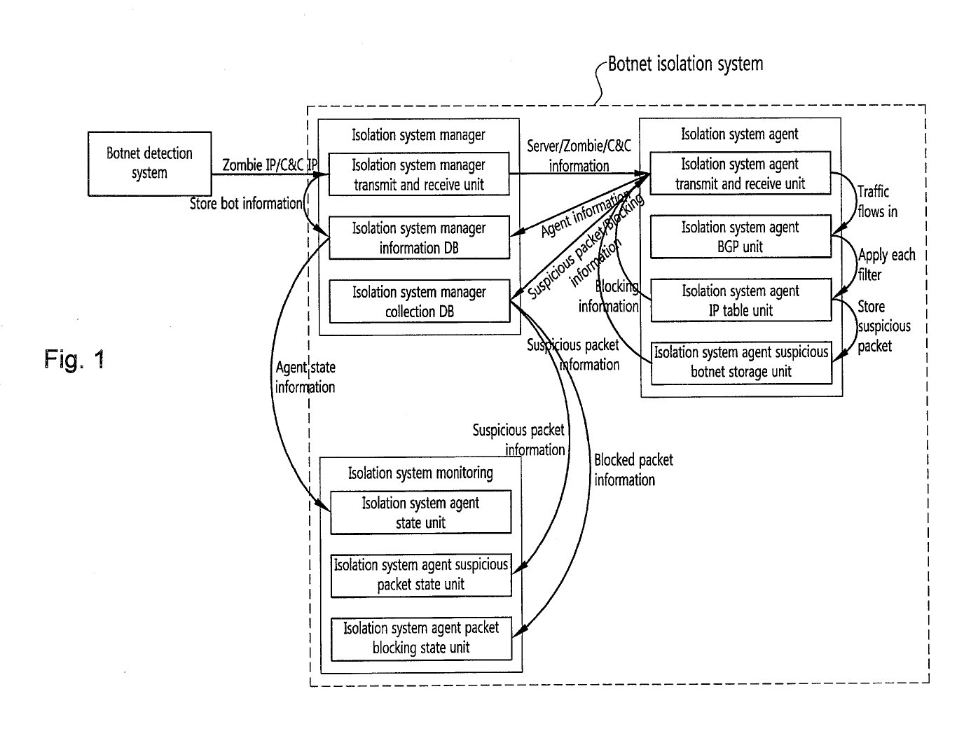

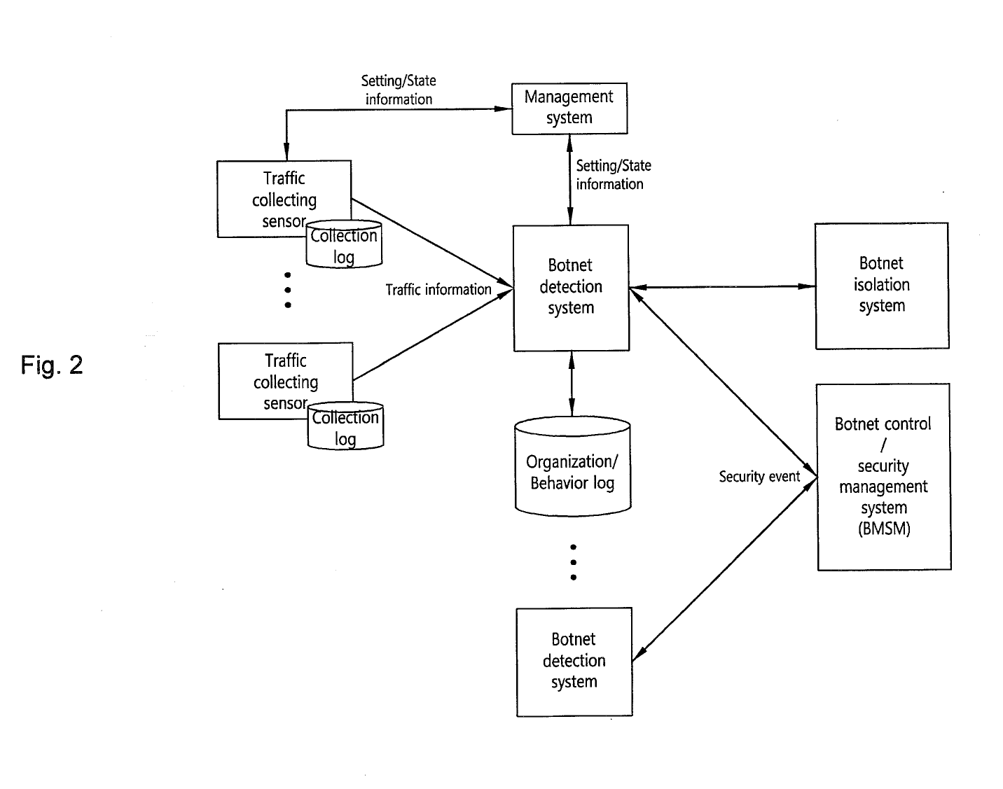

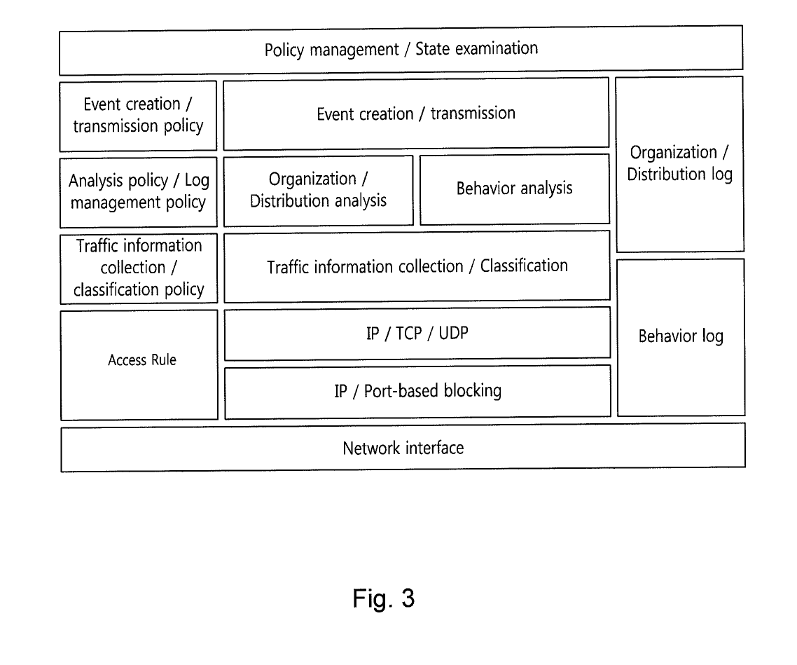

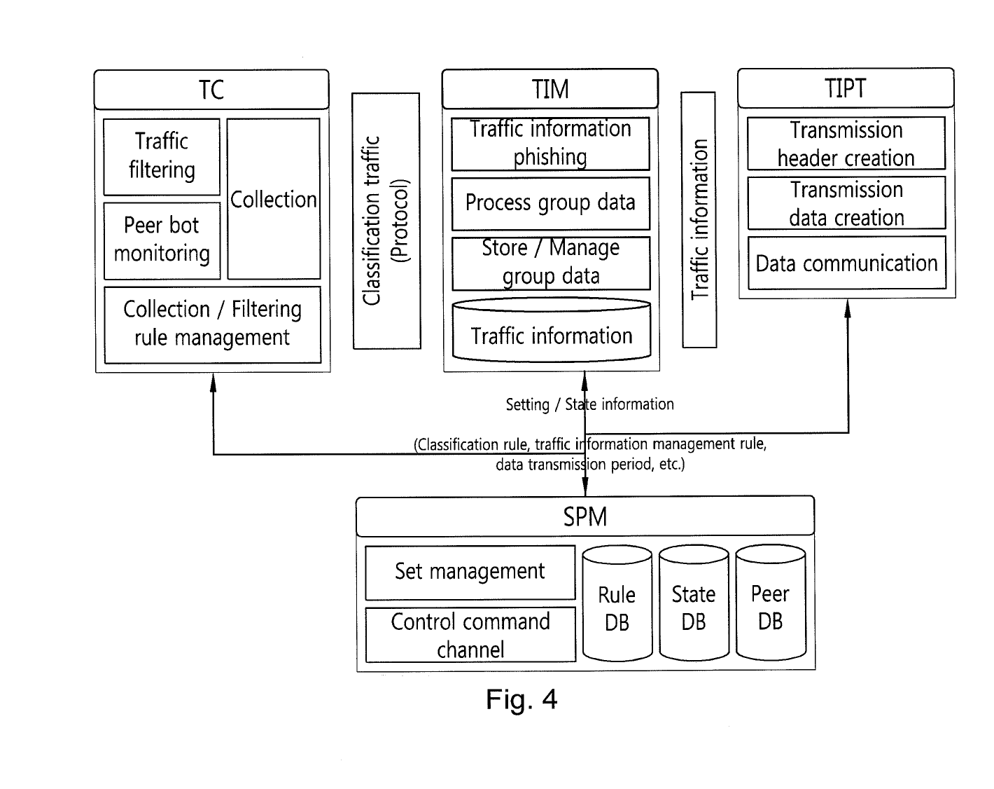

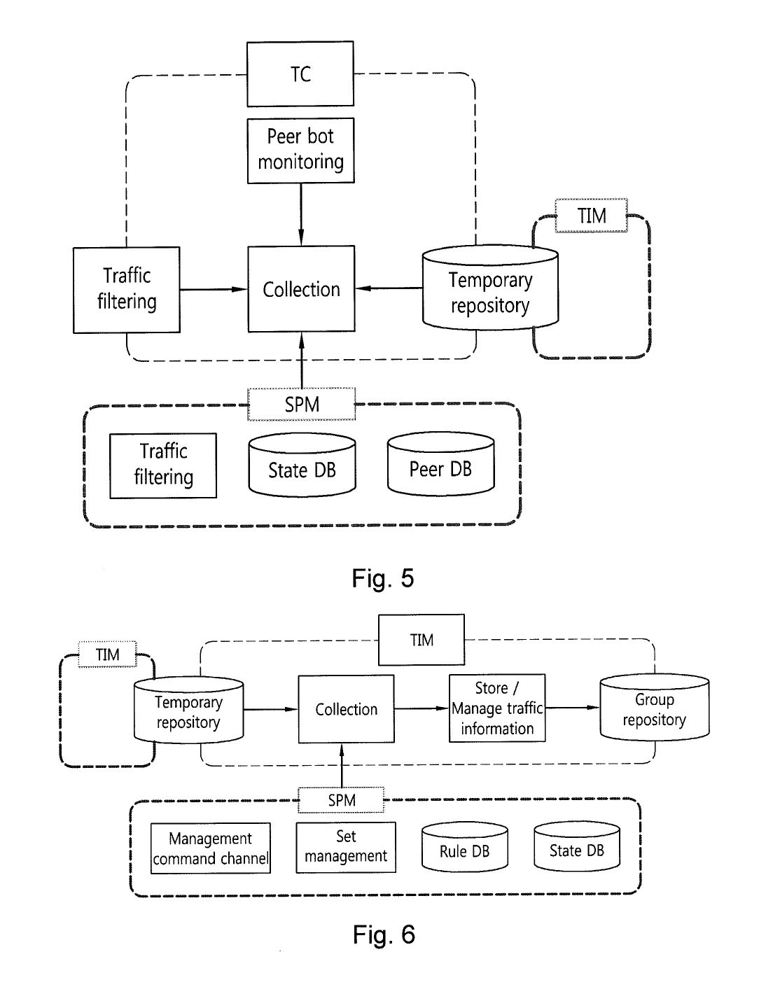

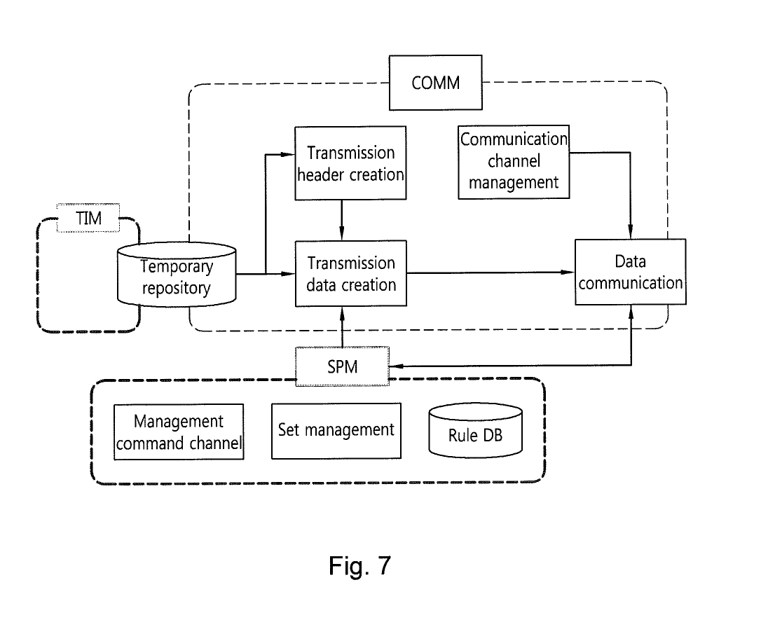

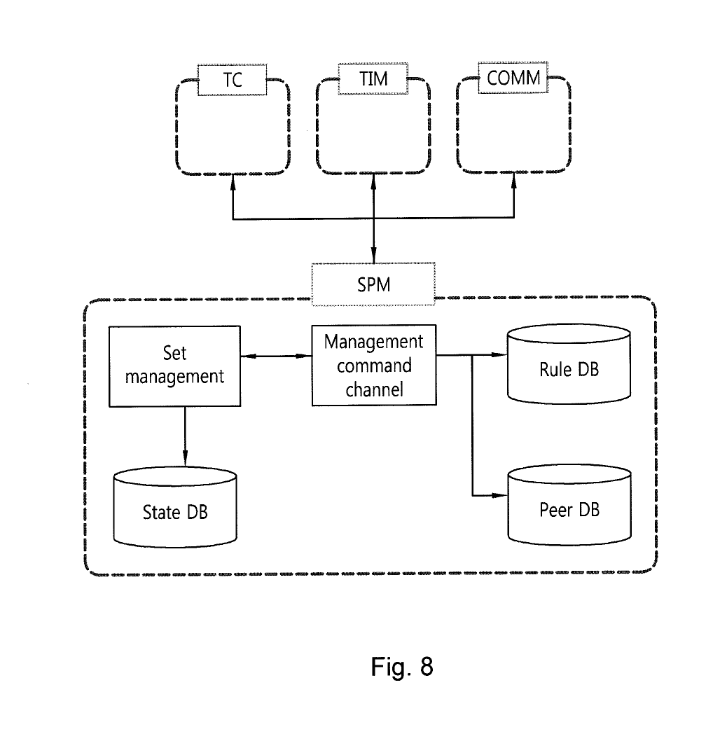

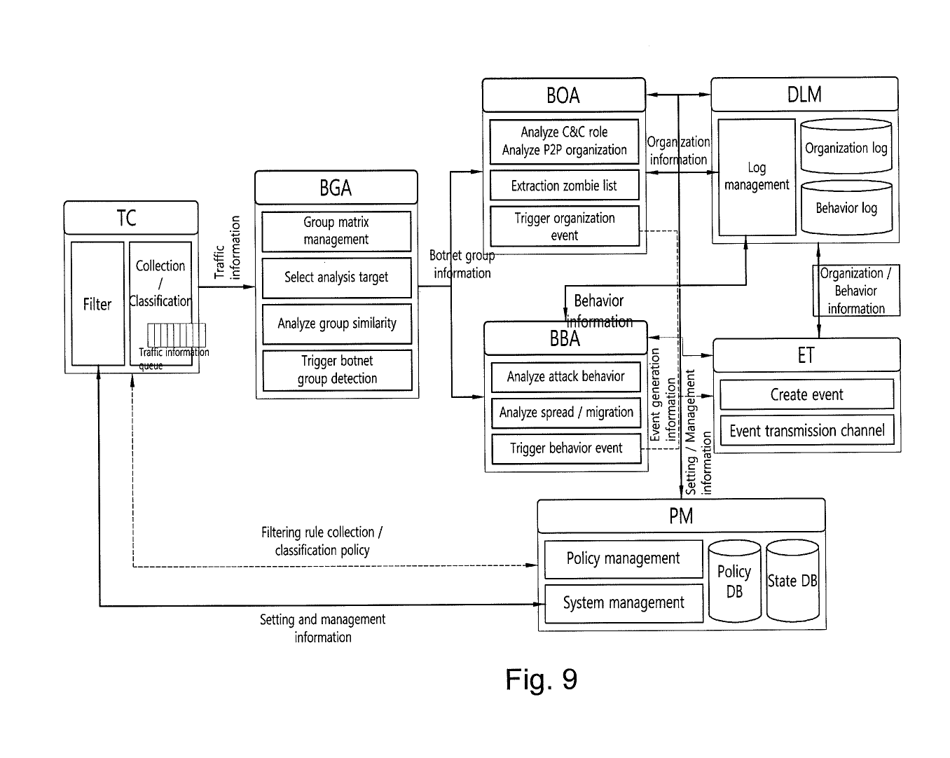

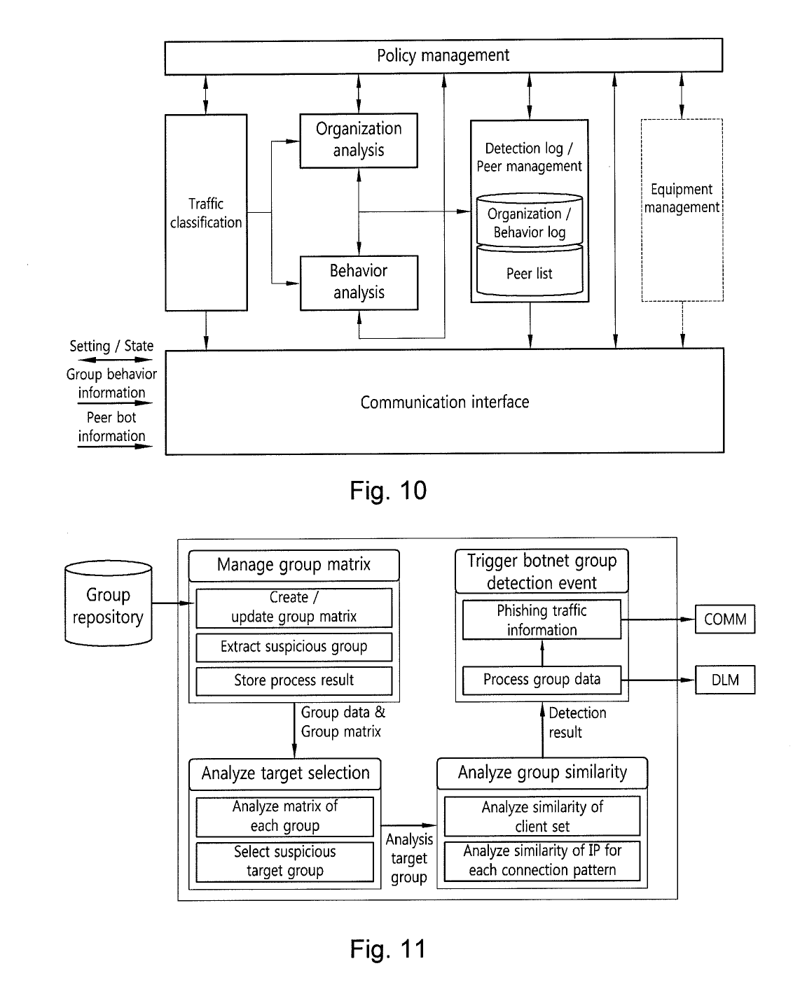

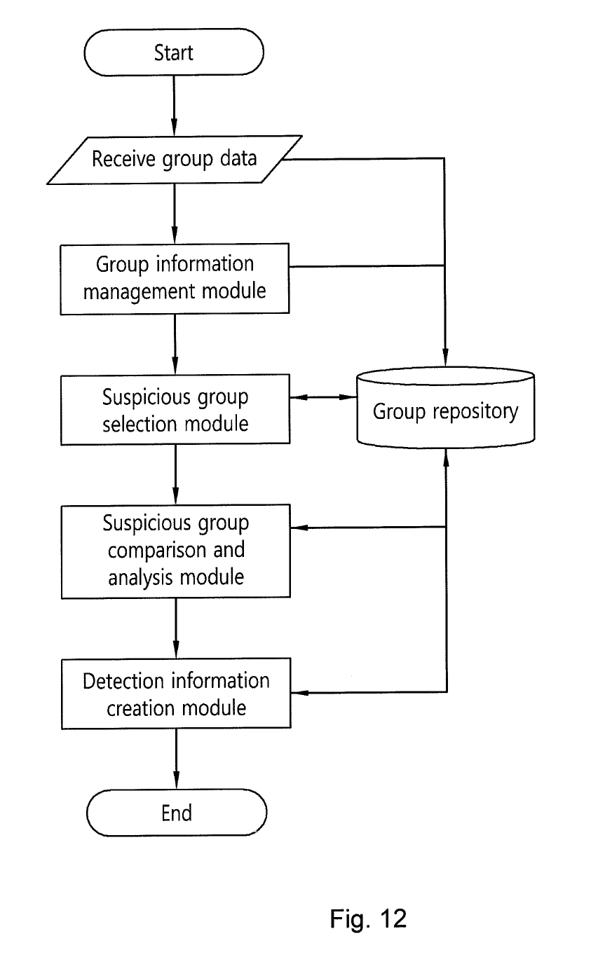

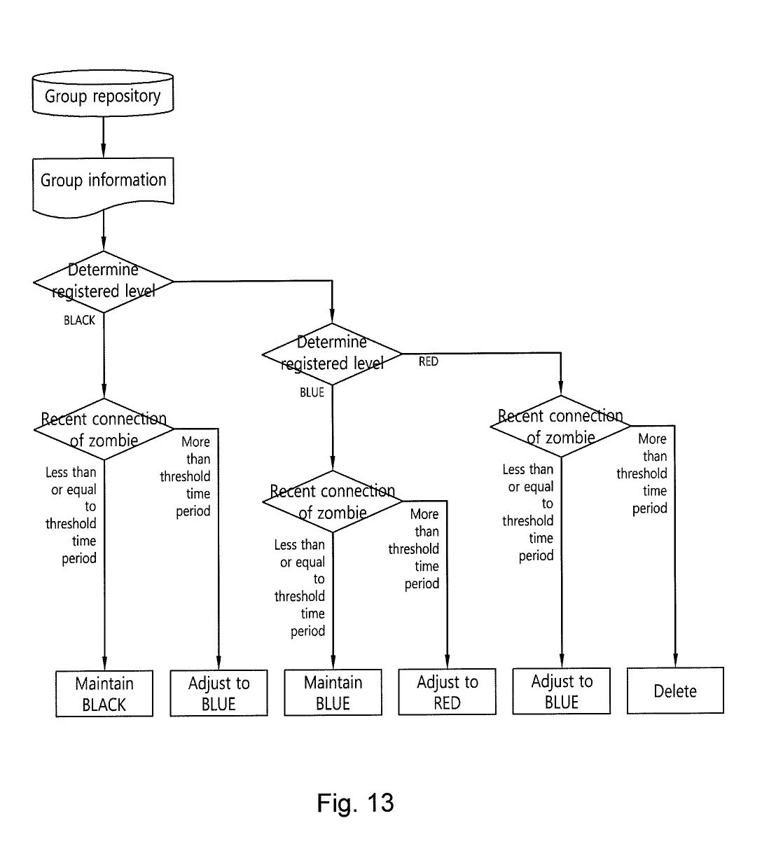

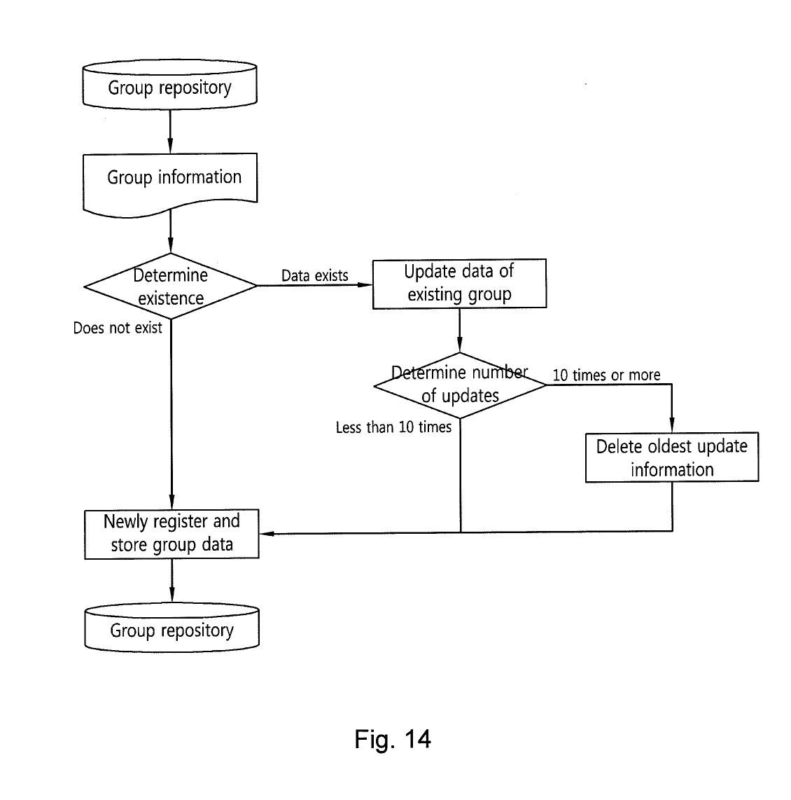

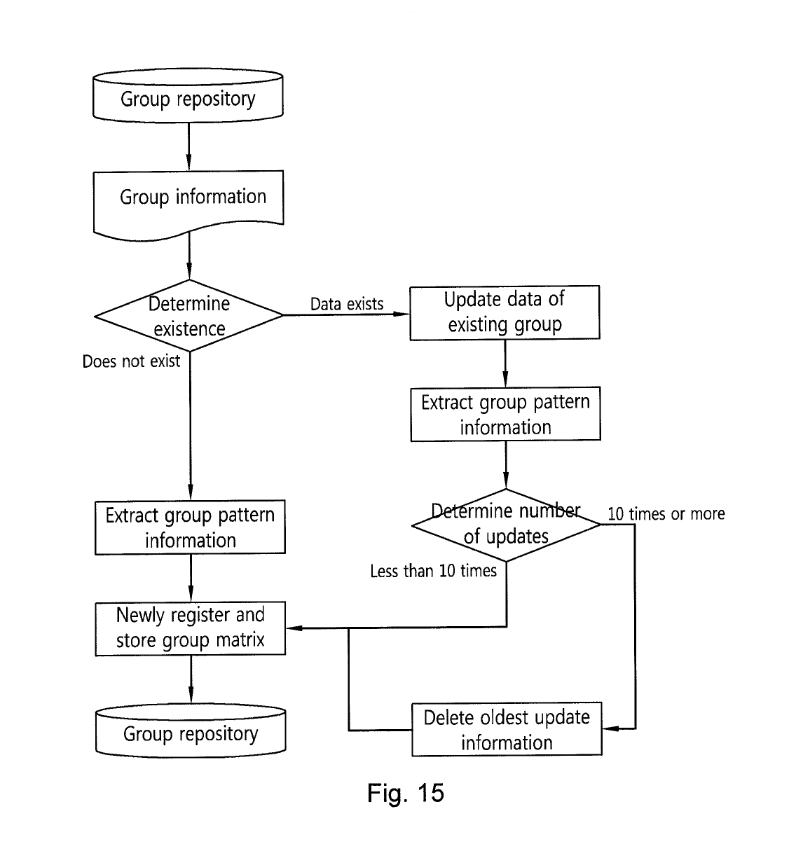

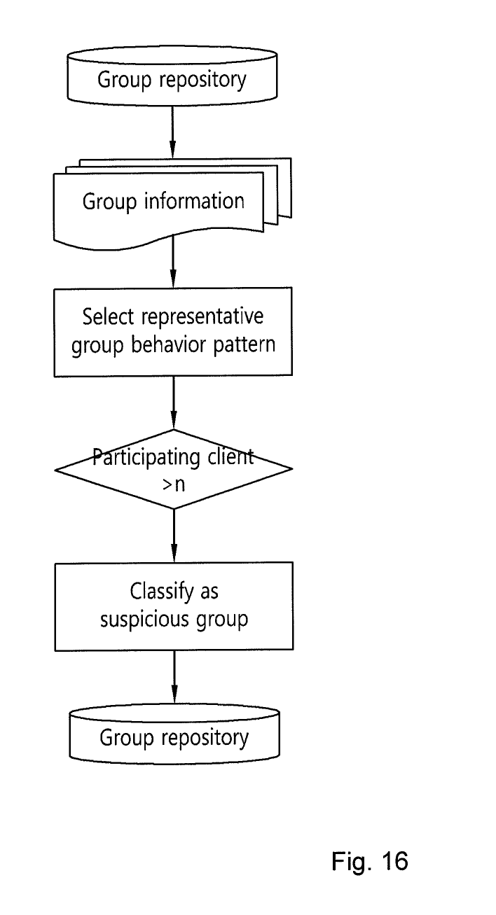

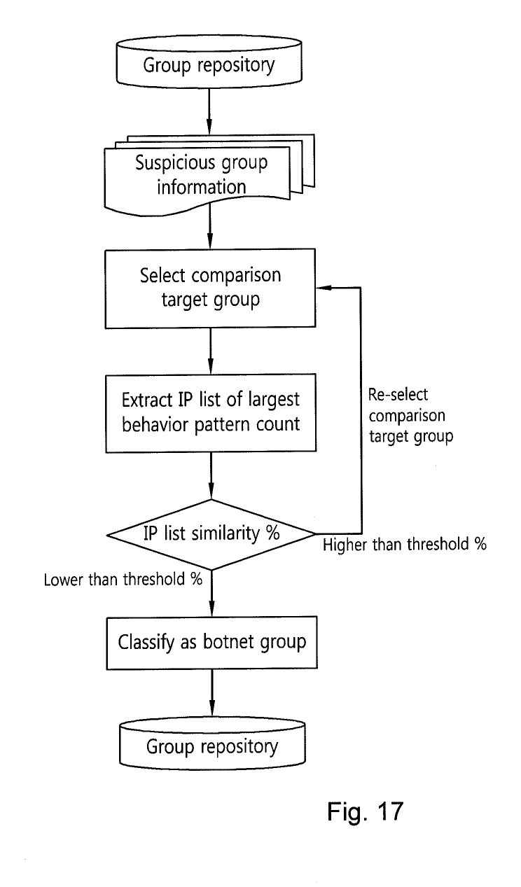

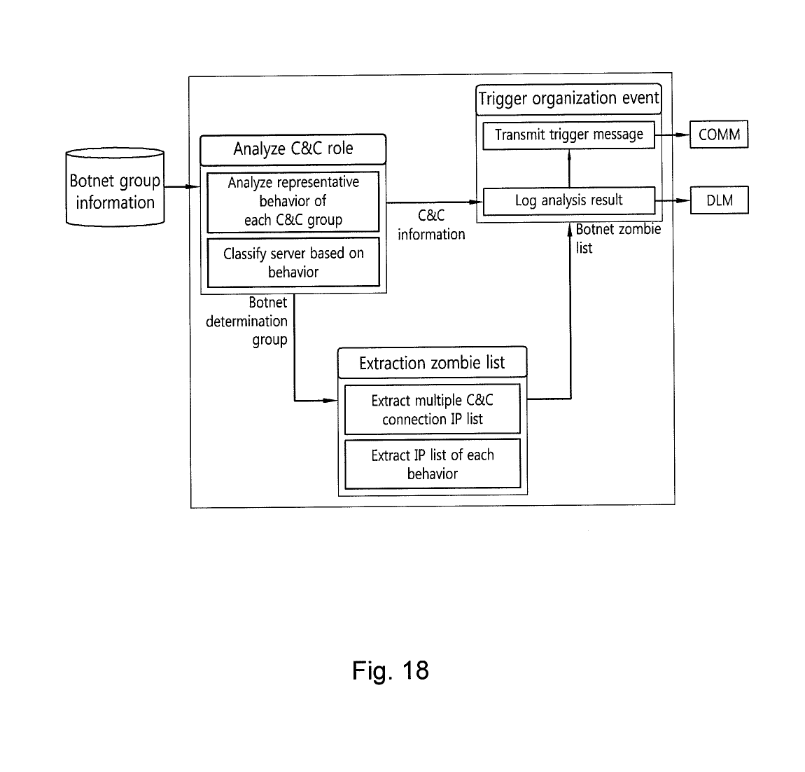

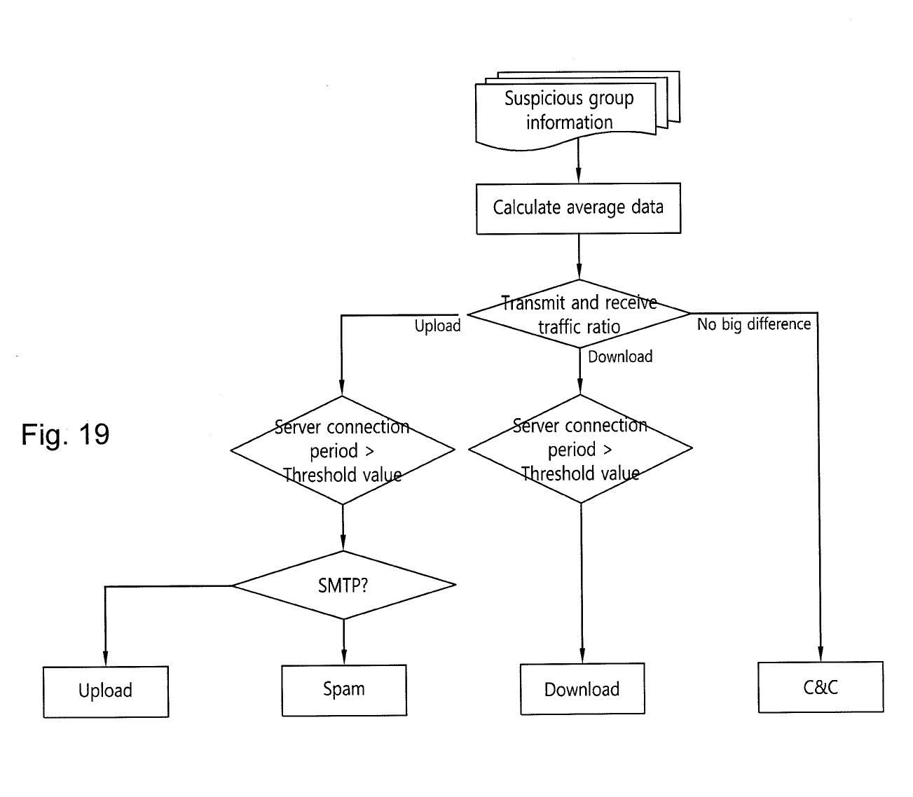

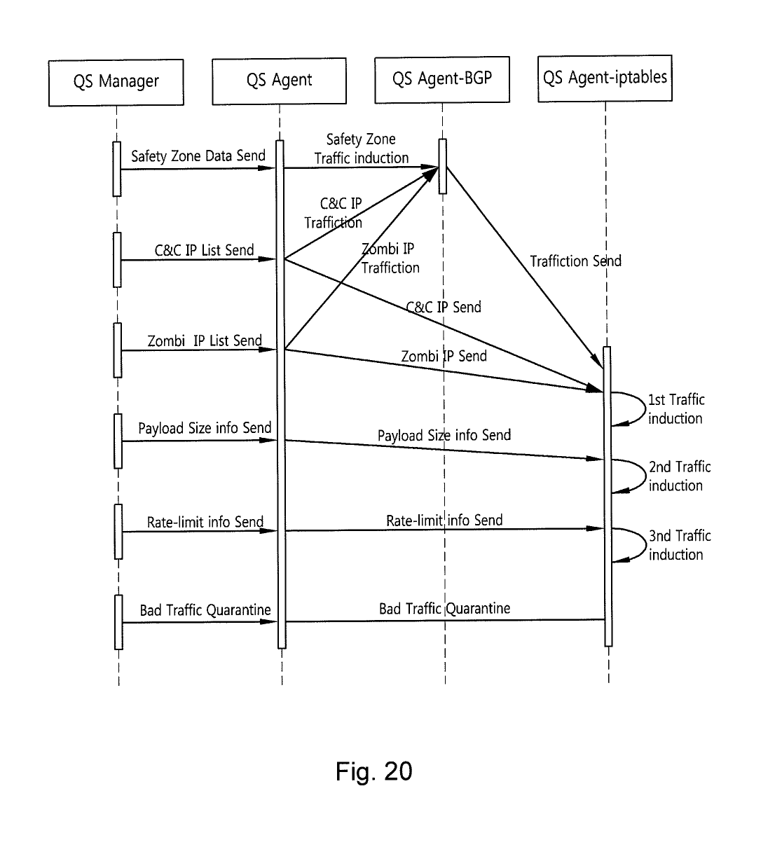

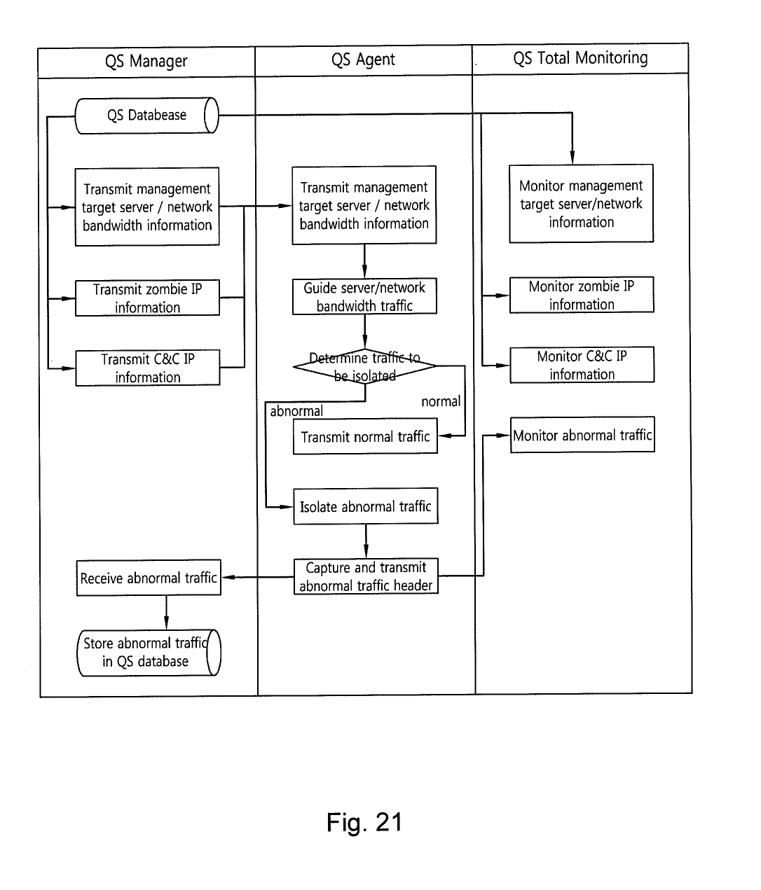

FIG. 1 is a block diagram conceptually showing a malicious traffic isolation system using botnet information according to the present invention, and FIG. 2 is a conceptual view showing connections needed for operating the malicious traffic isolation system according to the present invention. FIG. 3 is a view showing the configuration of the malicious traffic isolation system using botnet information according to the present invention and FIG. 4 is a conceptual view showing a botnet traffic collecting sensor of the malicious traffic isolation system using botnet information according to the present invention. FIG. 5 is a view showing the configuration of a traffic information collecting module of the malicious traffic isolation system using botnet information according to the present invention, and FIG. 6 is a view showing the configuration of a traffic information management module of the malicious traffic isolation system using botnet information according to the present invention. FIG. 7 is a view showing the configuration of a management communication module of the malicious traffic isolation system using botnet information according to the present invention, FIG. 8 is a view showing the configuration of a sensor policy management module of the malicious traffic isolation system using botnet information according to the present invention. FIG. 9 is a view showing the configuration of a botnet detection system of the malicious traffic isolation system using botnet information according to the present invention, and FIG. 10 is a view showing the structure of the botnet detection system of the malicious traffic isolation system using botnet information according to the present invention. FIG. 11 is a view showing the configuration of a botnet group analyzer of the malicious traffic isolation system using botnet information according to the present invention, and FIG. 12 is a flowchart illustrating the operation of the botnet group analyzer of the malicious traffic isolation system using botnet information according to the present invention. FIG. 13 is a flowchart illustrating the operation of a group information management module of the malicious traffic isolation system using botnet information according to the present invention, and FIG. 14 is a flowchart illustrating the operation of a group data management module of the malicious traffic isolation system using botnet information according to the present invention. FIG. 15 is a flowchart illustrating the operation of a group matrix management module of the malicious traffic isolation system using botnet information according to the present invention, and FIG. 16 is a flowchart illustrating the operation of a suspicious group selection module of the malicious traffic isolation system using botnet information according to the present invention. FIG. 17 is a flowchart illustrating the operation of a suspicious group comparison and analysis module of the malicious traffic isolation system using botnet information according to the present invention, and FIG. 18 is a view showing the configuration of a botnet organization analyzer of the malicious traffic isolation system using botnet information according to the present invention. FIG. 19 is a flowchart illustrating the operation of the botnet organization analyzer of the malicious traffic isolation system using botnet information according to the present invention, and FIG. 20 is a sequence diagram showing overall signaling between an isolation system manager and an isolation system agent of the malicious traffic isolation system using botnet information according to the present invention. FIG. 21 is a sequence diagram showing the operation among detailed modules of the botnet isolation system in the malicious traffic isolation system using botnet information according to the present invention;

As shown in FIG. 1, the malicious traffic isolation system using botnet information according to the present invention comprises a botnet group detection system and a botnet isolation system. The botnet group detection system described below is merely an example, and any botnet group detection system may be used in the present invention. That is, for example, as well as the botnet group detection system for detecting botnet groups, a botnet detection system or the like that can detect botnets using a general method other than botnet groups can be used in the present invention.

As shown in FIGS. 2 and 3, the botnet group detection system comprises botnet traffic collecting sensors, and botnet detection systems for detecting botnets based on botnet traffics collected by the botnet traffic collecting sensors.

The botnet traffic collecting sensor serves to collect traffics of a corresponding Internet service provider's network in order to detect botnets and comprises a traffic information collecting module, a traffic information management module, a management communication module, and a sensor policy management module as shown in FIG. 4.

As shown in FIG. 5, the traffic information collecting module collects traffic data of a monitoring network and traffic data of a network using a packet capture tool based on data collection policies. The collected traffic information is stored in a temporarily repository of a traffic information repository, and the collected traffic information stored in the temporarily repository is processed by the traffic information management module.

As shown in FIG. 6, the traffic information management module classifies the information received from the traffic information collecting module, receives and parses the traffic information, processes grouped behavior information, i.e., group data and peer bot information, and stores and manages traffic information corresponding to the grouped behavior information in a database. At this point, the traffic information can be classified and grouped based on a pattern as described below.

As shown in FIG. 7, the management communication module) divides the traffic information parsed by the traffic information management module into a transmission header and a transmission data, packages the data, and transmits the data to the botnet detection system through a transmission channel.

As shown in FIG. 8, the sensor policy management module has a function of setting and controlling overall botnet traffic collecting sensors and interacts with all modules. The set management module of the sensor policy management module manages a state database, and the management command channel updates and manages a rule database and a peer database. The management communication module (COMM) receives and stores information in the rule database and the peer database, and the traffic information collecting module (TC), the traffic information management module (TIM), and the management communication module (COMM) access the state database and record work logs.

The botnet detection system is provided in an Internet service provider's network and detects botnets operating in the Internet service provider's network based on the traffic information collected by the botnet traffic collecting sensor. One or more of such a botnet detection system can be provided in the corresponding Internet service provider's network. In addition, as shown in FIGS. 9 and 10, the botnet detection system includes a botnet group analyzer (BGA), a botnet organization analyzer (BOA), a botnet behavior analyzer (BBA), a detection log management module (DLM), an event transfer module (ET), and a policy management module (PM).

As shown in FIG. 11, the botnet group analyzer BGA determines botnet groups from the group data transmitted from the botnet traffic collecting sensors. The group data transmitted from the botnet traffic collecting sensors is used to create or update a matrix of groups, and the group matrix is updated or deleted based on a group management algorithm. At this point, if a matrix is not updated for more than 50 percent of agents in an entire group, the matrix is deleted according to management steps. In addition, the botnet group analyzer manages the matrix of group data. The botnet group analyzer updates the matrix of an existing group and creates a matrix for a new group. Referring to the update, a group matrix is deleted based on a group matrix management algorithm if clients belonging to the group are not active for a predetermined period of time. In addition, if a specific connection pattern of a group matrix goes above a threshold value after the group matrix is updated, the corresponding group is determined as an analysis target group. Then, similarity of clients is analyzed for the groups determined as an analysis target group. If the similarity is higher than a predetermined value, e.g., 80 percent, similarity is analyzed for a detailed client list with respect to a representative specific connection pattern. At this point, if the similarity of clients for a specific connection pattern is higher than a predetermined value, e.g., 80 percent, the corresponding two groups are determined as the same botnet. In addition, the results analyzed by respective modules are integrated and transmitted to a log manager, and a trigger message to be used as a policy in the future is created from the analysis result and transmitted to an event trigger. In order to perform the functions described above, the botnet group analyzer comprises a group information management module, a suspicious group selection module, a suspicious group comparison and analysis module, and a detection information creation module. These modules will be described with reference to FIG. 12.

The group information management module stores the group data received from the botnet traffic collecting sensor into the botnet detection system and creates a group matrix from the group data. The group information management module manages the number of group information stored in the botnet detection system and, specifically, manages update of the group data and the group matrix. At this point, managing the group data and the group matrix is reflecting a corresponding update, whereas managing the number of information of the entire groups is managing the number of group information geometrically increasing in the botnet detection system.

Referring to FIG. 13, group information may have a plurality of levels, and a black, a red, and a blue are shown as an example in the present invention. The black is information on a group detected as a botnet, and the red is information on an inactive group, whereas the blue is information on a general group. The group information can be managed in a method of comparing a difference between a time when a client is connected and a current analysis time with a threshold time period and lowering a level if the client is not connected for the threshold time period. In addition, an inactive red group is preferably deleted if a client is not connected for more than the threshold time period. Such a group information management module includes a group data management module and a group matrix management module.

Referring to FIG. 14, the group data management module manages group data received from the botnet traffic collecting sensors within the botnet detection system. Since the botnet detection system manages data received from a plurality of botnet traffic collecting sensors, it needs to efficiently operate a large amount of group data. Accordingly, the group data are managed only for a specific time period, and this will flexibly vary depending on the amount of collected data. For example, a few number of time periods can be managed for managed group data. A recent update is reflected for updates transmitted thereafter, and the oldest update is deleted.

Referring to FIG. 15, the group matrix management module manages a group of matrixes, i.e., a group matrix, stored by analyzing an IP count based on a pattern of connection behaviors generated in a group. The group matrix management module preferably manages data only for a specific time period in the same manner as the group data management module described above.

Referring to FIG. 16, the suspicious group selection module selects a group suspicious as a botnet from information on managed groups and creates a list. That is, a group suspicious as a botnet is selected from the group information possessed by the botnet detection system. Clients participate in a behavior of a behavior matrix of a corresponding group, and a suspicious group is determined based on the scale of a corresponding agent for a behavior where the largest number of clients takes part in.

Referring to FIG. 17, the suspicious group comparison and analysis module determines a botnet group by comparing and analyzing similarity among the groups classified as a suspicious group. To this end, groups to be compared should be selected from the suspicious groups. In addition, since the groups to be compared should be empirically compared with one another, the order of comparison among the groups can be determined without any special precedence by sorting the groups in order of the ID value of each group. For the two groups selected to be compared, IP lists of clients showing a behavior where the largest clients have participated in among the behavior pattern of each group are compared. At this point, since the size of a client IP set of each group can be different from those of the others, it is preferable that the groups are analyzed as much as a small set becomes a subset of a large set.

The detection information creation module creates information on a group determined as a botnet by the suspicious group comparison and analysis module. The information on the botnet group may include a client IP, behavior of a corresponding botnet, and the like.

As shown in FIG. 18, the botnet organization analyzer BOA analyzes a representative connection pattern of each group for the botnet groups detected as a botnet in order to analyze the role of C&C and extract a zombie list. In addition, the BOA classifies the role of each server participating in a botnet based on group information related to the connection pattern. At this point, referring to FIG. 19, a result of the classification can be divided into a command control server, a download server, an upload server, and a spam server. An IP list, i.e., a zombie list, of each group is extracted for the groups detected as a botnet. The final update time is analyzed for each zombie list, and if the final update time has connectivity lower than a threshold value, the group is determined as a zombie. At this point, information is constructed by analyzing the final server connection time of each zombie so that evolution of the botnet organization can be analyzed with respect to the role of each server. In addition, the results analyzed by respective modules are integrated and transferred to the log manager. A trigger message to be used as a policy in the future is created from the analysis result and transferred to the event trigger.

The botnet behavior analyzer BBA analyzes attacks of a botnet group and whether the botnet group has spread or migrated.

The detection log management module DLM manages logs on organization and behavior information of a botnet group and includes an organization information database and a behavior information database of the botnet group.

The policy management module PM sets policies on the modules executed within a botnet control and security management system. In addition, the policy management module sets detection policies of botnet detection systems registered in the botnet control and security management system. In addition, the policy management module sets policies of the traffic information collecting sensors through the registered botnet detection systems.

The botnet control and security management system exchanges a variety of settings and state information with a control system, receives group behavior information related to a botnet and peer bot information from the botnet traffic collecting sensor, classifies traffics, analyzes organization and behavior of the botnet, and stores the analyzed organization and behavior information in a database. In addition, the botnet control and security management system transmits the organization and behavior analysis information stored in the database to the control system.

The botnet isolation system guides and isolates traffics transmitted from botnet groups detected by the botnet group detection system, i.e., PCs and C&C servers infected with a bot, in a quarantine area. As shown in FIG. 1, the botnet isolation system comprises an isolation system manager, an isolation system agent, and an isolation system monitor.

The isolation system manager transmits botnet group information including a protect target list, a zombie IP and C&C IP list. The isolation system manager comprises an isolation system manager transmit and receive unit in charge of information transmitted from the botnet detection system and information exchanged with the isolation system agent, an information database for storing information on the states of the botnet detection system and the isolation system agent and bot information transferred from the isolation system manager, and a collection database for storing information on suspicious packets transmitted from the isolation system agent and blocking information.

The isolation system agent isolates a botnet group based on the botnet group information transmitted from the isolation system manager. The isolation system agent comprises an isolation system agent transmit and receive unit for receiving a protect target list, a zombie IP and C&C IP list transmitted from the isolation system manager transmit and receive unit of the isolation system manager and transmitting information on suspicious traffics and information on blockage of the suspicious traffics to the collection database, a BGP unit for receiving traffics for each protect target through the isolation system agent, an IP table unit for controlling filtering of the received traffics, and a suspicious botnet storage unit for temporarily storing the suspicious traffics and transmitting the suspicious traffics to the isolation system agent. At this point, the sequence between the isolation system manager and the isolation system agent is as shown in FIG. 20.

The isolation system monitor monitors the botnet isolation system in real-time and comprises an isolation system agent state unit for receiving a state of the isolation system agent from the information database and displaying the state in real-time, a suspicious packet state unit for receiving suspicious packets from the collection database and displaying the suspicious packets in real-time, and a packet blocking state unit for receiving blocked packet information from the collection database and displaying the packet information in real-time.

The botnet isolation system structured like this operates as shown in FIG. 21. The botnet isolation system accommodates traffics received from a PC and a C&C server infected with a bot into a quarantine area, isolates normal traffics from traffics transmitted from malicious bots, and blocks the malicious traffics. In addition, the botnet isolation system provides statistics data on the isolated botnet traffics and provides selected traffic contents. The botnet isolation system may provide a variety of filtering functions (e.g., filtering based on host and C&C IP, payload size, rate-limit, or rate filtering) in association with the botnet detection system and a function of mitigating DDoS attacks of a botnet.

Next, a malicious traffic isolation method using botnet information according to the present invention will be described with reference to the drawings. Those described above in the malicious traffic isolation system using botnet information according to the present invention will be omitted or briefly described.

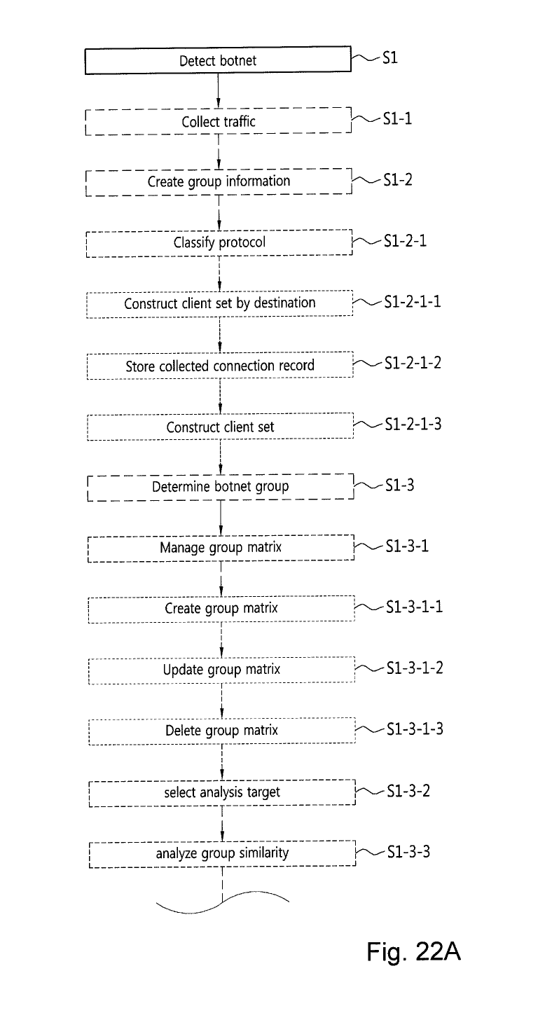

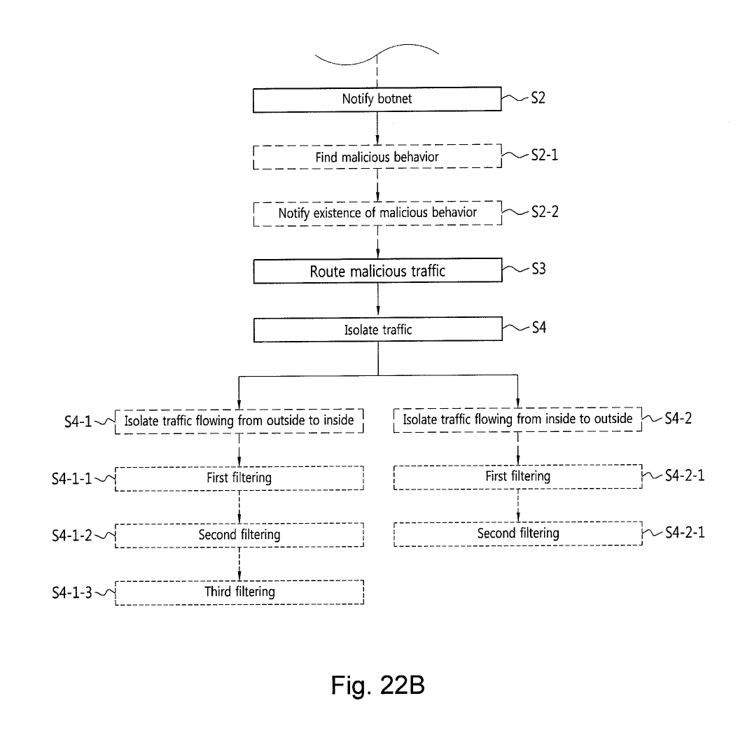

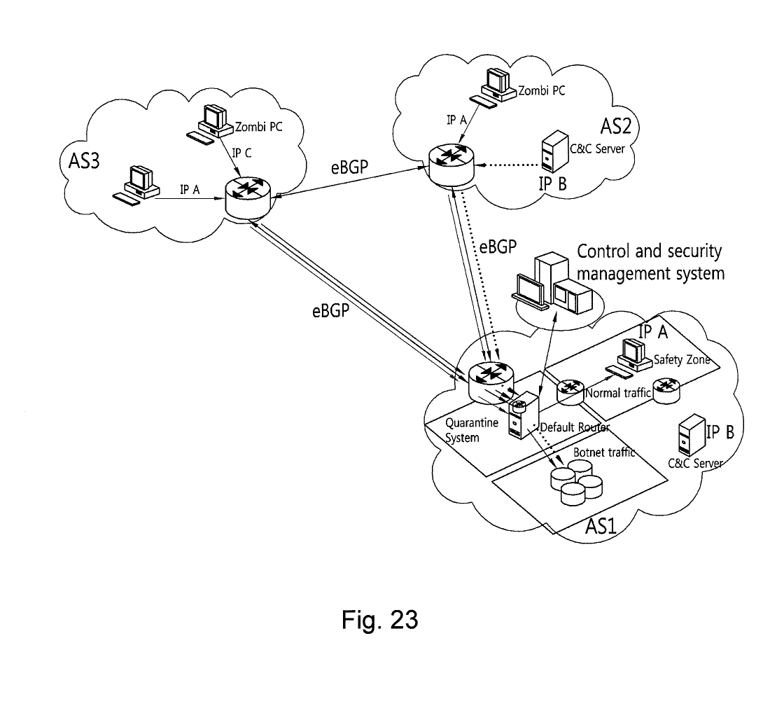

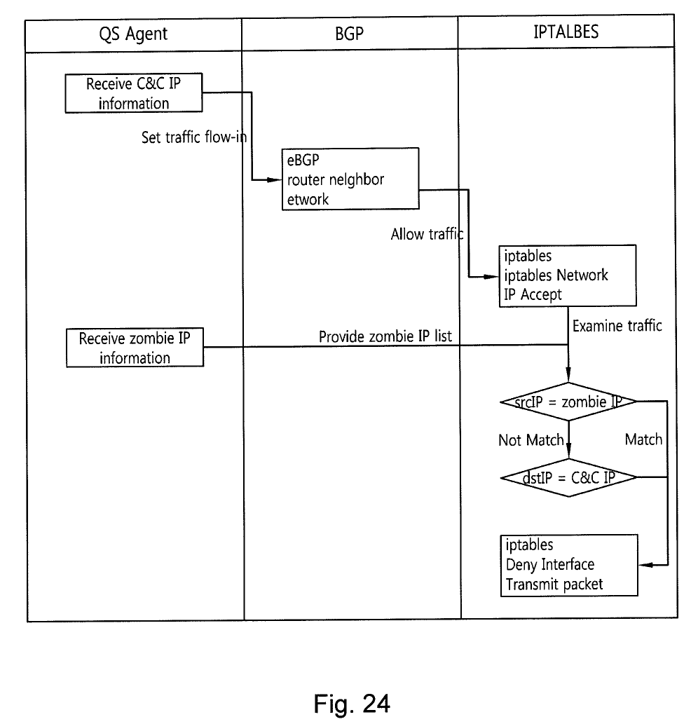

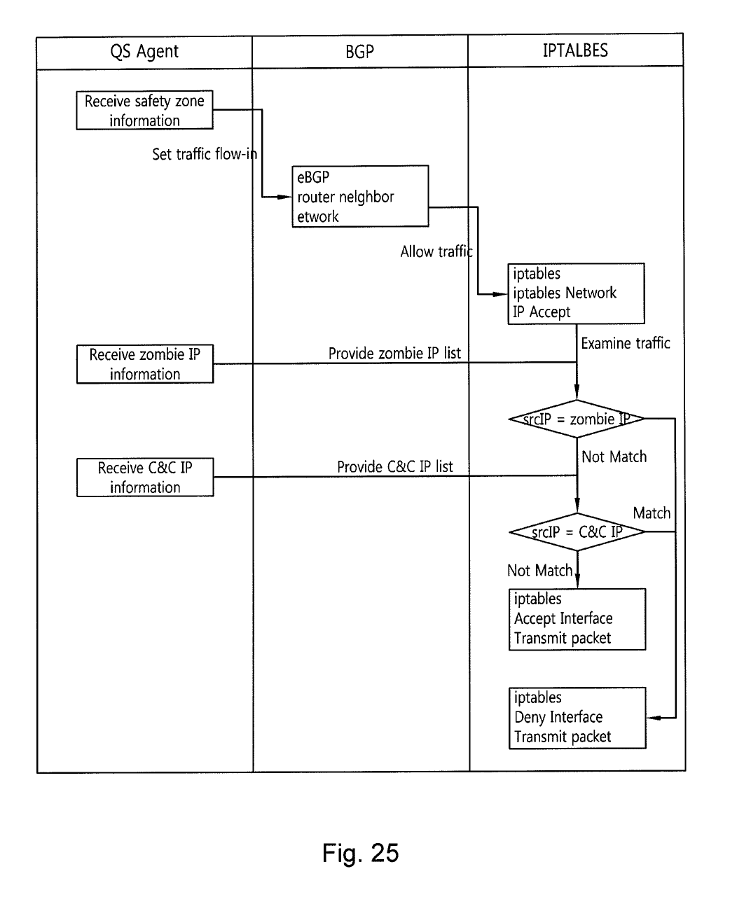

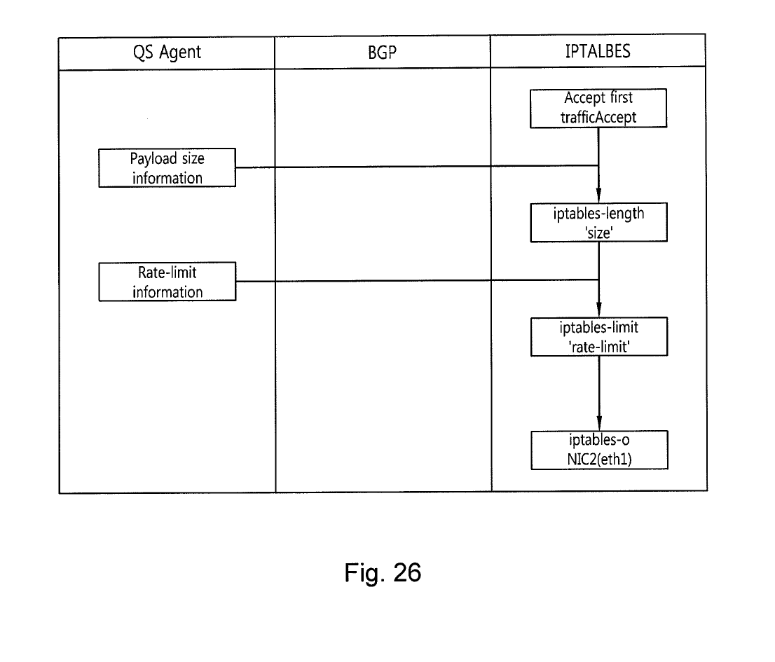

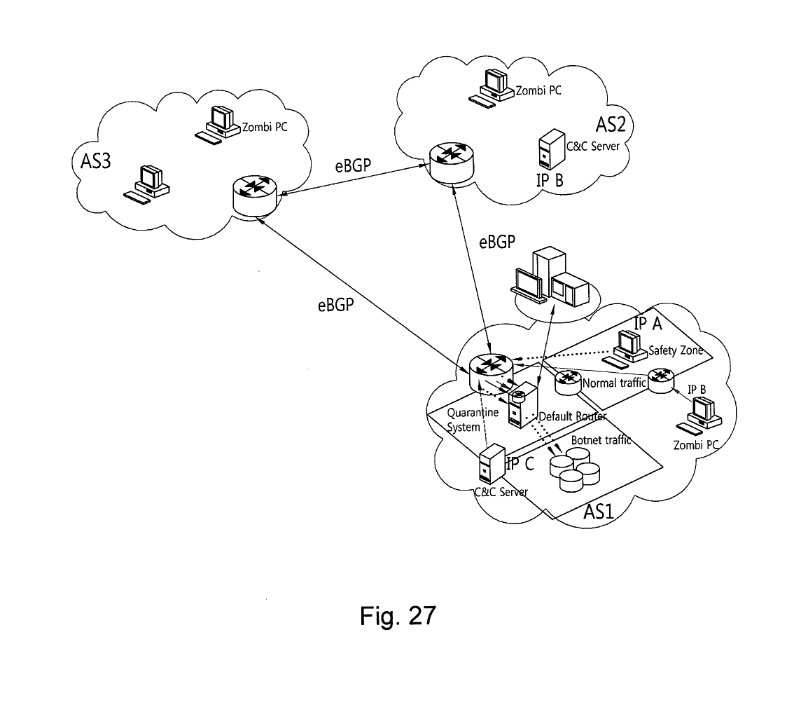

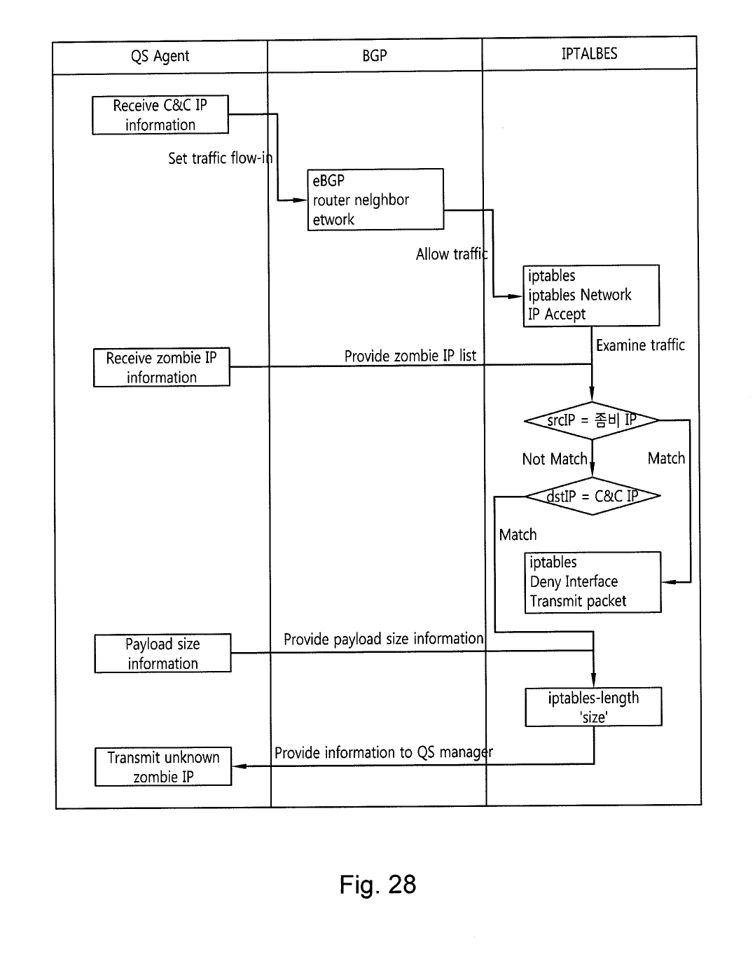

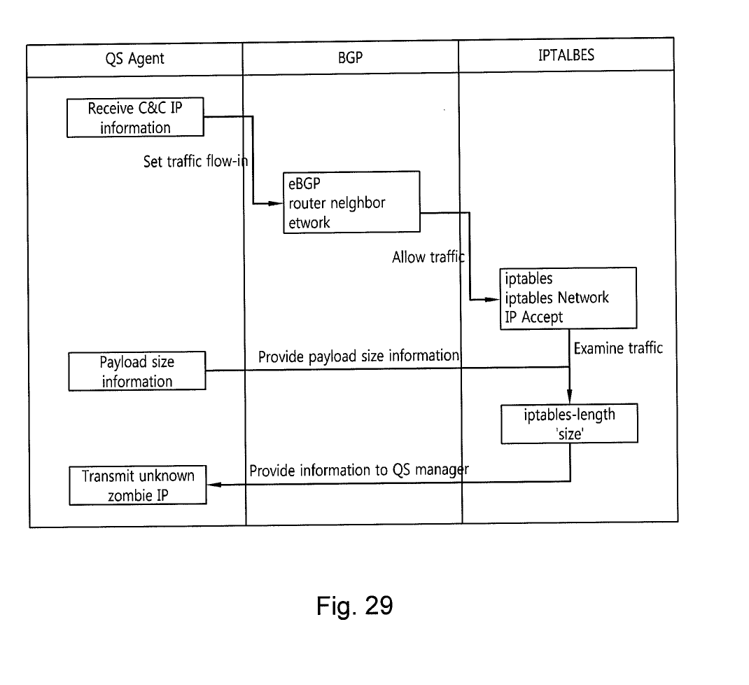

FIG. 22 is a flowchart illustrating a malicious traffic isolation method using botnet information according to the present invention, and FIG. 23 is a conceptual view showing a botnet isolation system technology applied to traffics flowing from outside to inside of a network, in the malicious traffic isolation method using botnet information according to the present invention. FIG. 24 is a block diagram showing a counter-attack algorithm applied to flowing-in traffics based on an internal C&C IP of a network, in the malicious traffic isolation method using botnet information according to the present invention, and FIG. 25 is a block diagram showing a counter-attack algorithm applied when a safety zone within a network is determined as a traffic flow-in target, in the malicious traffic isolation method using botnet information according to the present invention. FIG. 26 is a block diagram showing a second and third filtering algorithm applied when traffics flowing from outside to inside of a network are isolated, in the malicious traffic isolation method using botnet information according to the present invention, and FIG. 27 is a conceptual view showing a botnet isolation system technology applied to traffics flowing from inside to outside of a network, in the malicious traffic isolation method using botnet information according to the present invention. FIG. 28 is a block diagram showing a counter-attack algorithm applied when an external C&C IP is a target of traffic flowing out of a network in the case where traffics flowing from inside to outside of the network are isolated, in the malicious traffic isolation method using botnet information according to the present invention, and FIG. 29 is a block diagram showing a counter-attack algorithm applied when a zombie IP is determined as a target of traffic flowing out of a network in the case where traffics flowing from inside to outside of the network are isolated, in the malicious traffic isolation method using botnet information according to the present invention.

As shown in FIG. 22, the malicious traffic isolation method using botnet information according to the present invention comprises the steps of detecting a botnet S₁, notifying the botnet S₂, routing malicious traffics S₃, and isolating the traffics S₄. The step of detecting a botnet S₁ described below is merely an example, and any method that can detect a botnet can be used as the step of detecting a botnet S₁ in the present invention.

The step of detecting a botnet S₁ comprises the steps of collecting traffics S₁₋₁, creating group information S₁₋₂, and determining a botnet group S₁₋₃.

The step of collecting traffics S₁₋₁ collects traffic data of a network using a packet capture tool based on collection policies. To this end, traffic information collecting sensors are provided in a plurality of networks and collect traffic information based on traffic collection policies set by the botnet control and security management system.

The step of creating group information S₁₋₂ divides the collected traffics into groups. To this end, the step of creating group information S₁₋₂ includes the step of classifying a protocol S₁₋₂₋₁.

The step of classifying a protocol S₁₋₂₋₁ classifies the traffics collected in the step of collecting traffics by the protocol. The step of classifying a protocol includes the step of constructing a client set by the destination S₁₋₂₋₁₋₁.

The step of constructing a client set by the destination S₁₋₂₋₁₋₁ analyzes the protocol collected in the step of collecting traffics and constructs a set of clients having the same destination. The step of constructing a client set by the destination S₁₋₂₋₁₋₁ includes the steps of storing collected connection records S₁₋₂₋₁₋₁₋₁ and constructing a client set S₁₋₂₋₁₋₁₋₂.

The step of storing collected connection records S₁₋₂₋₁₋₁₋₁ stores connection records collected by the traffic information collecting sensors and connection records collected during a predetermined time period.

The step of constructing a client set S₁₋₂₋₁₋₁₋₂ analyzes the collected traffic information, divides the traffics by the protocol, and constructs the traffics into client sets. The protocol is largely classified into TCP and UDP as is in the malicious traffic isolation system using botnet information according to the present invention described above. TCP is divided into HTTP, SMTP, and other HTTPs. UDP is divided into DNS and other DNSs. At this point, the protocol is classified by analyzing contents of real traffics, and group data is constructed based on the IP and port, i.e., the destination address.

The step of determining a botnet group S₁₋₃ determines a botnet group by comparing and analyzing similarity among the groups classified as a suspicious group. The step of determining a botnet group includes the steps of managing a group matrix S₁₋₃₋₁, selecting an analysis target S₁₋₃₋₂, and analyzing group similarity S₁₋₃₋₃.

The step of managing a group matrix S₁₋₃₋₁ manages a matrix of group data transmitted from the traffic information collecting module, i.e., a group matrix. Here, management of group matrix means creating, updating, and deleting a group matrix. Accordingly, the step of managing a group matrix includes the steps of creating a group matrix S₁₋₃₋₁₋₁, updating a group matrix S₁₋₃₋₁₋₂, and deleting a group matrix S₁₋₃₋₁₋₃.

The step of creating a group matrix S₁₋₃₋₁₋₁ creates a group matrix for a new group. That is, if a group is a new group that does not exist, a group matrix is created since the group matrix does not exist.

If a corresponding group exists, the step of updating a group matrix S₁₋₃₋₁₋₂ updates the matrix of the existing group.

The step of deleting a group matrix S₁₋₃₋₁₋₃ deletes a group matrix based on the group matrix management algorithm if clients belong to the group are not active for a predetermined period of time.

If a specific connection pattern of a group matrix goes above a threshold value after the group matrix is updated, the step of selecting an analysis target S₁₋₃₋₂ selects the corresponding group as an analysis target group.

The step of analyzing group similarity S₁₋₃₋₃ analyzes similarity of clients for the groups determined as an analysis target group. If similarity is higher than a predetermined level, for example, 80 percent, similarity is analyzed on a detailed client list of a representative specific connection pattern. In addition, if similarity between clients is higher than a predetermined level in a specific connection pattern, for example, 80 percent, the corresponding two groups are determined as the same botnet.

The step of notifying the botnet S₂ notifies the botnet detected in the step of detecting a botnet S₁ to the botnet isolation system. This can be performed through the steps of finding a malicious behavior S₂₋₁ and notifying existence of the malicious behavior S₂₋₂.

The step of finding a malicious behavior S₂₋₁ selects suspicious packets performing a malicious behavior using the protect target list extracted by the botnet detection system and a zombie IP and C&C IP list.

A malicious behavior is found through the step of finding a malicious behavior S₂₋₁ performed to isolate traffics of the botnet, and the step of notifying the malicious behavior S₂₋₂ notifies information on the suspicious packets in order to block traffics of the botnet performing the malicious behavior.

The step of routing malicious traffics S₃ receives existence of malicious behavior and sets routing information in order to examine malicious traffics through the botnet isolation system. A routing command may use any known protocol used in a network, such as eBGP, iBGP, OSPF, or the like. Since the routing protocol is applied differently depending on a network operating environment, the routing protocol is not limited to a specific one in the present invention.

The step of isolating the traffics S₄ includes the steps of isolating traffics flowing from outside to inside S₄₋₁ and isolating traffics flowing from inside to outside S₄₋₂.

As shown in FIG. 23, the step of isolating traffics flowing from outside to inside S₄₋₁ isolates suspicious traffics flowing from outside to inside of a network and comprises the steps of performing a first filtering S₄₋₁₋₁, performing a second filtering S₄₋₁₋₂, and performing a third filtering S₄₋₁₋₃.

The step of performing a first filtering S₄₋₁₋₁ isolates DDoS traffics starting from a zombie IP among the traffics headed for a safety zone as shown in FIG. 25 from communication traffics starting from a C&C IP as shown in FIG. 24. In addition, the first filtering step isolates communication traffics starting from the zombie IP among the traffics headed for the C&C IP from traffics starting from an unknown IP.

As shown in FIG. 26, the step of performing a second filtering S₄₋₁₋₂ secondarily determines and isolates the DDoS traffics by repeatedly verifying the traffics using L2/L3/L4 information, the number of packets flowing in per unit time PPS, the number of bandwidths per unit time BPS, and the payload size of a corresponding traffic.

If a large amount of traffics flow in from outside to inside after the first and second filtering steps are performed as shown in FIG. 26, the step of performing a third filtering S₄₋₁₋₃ applies rate-limit. This can be implemented like, for example, Commit Access Rate (CAR) of CISCO.

The step of isolating traffics flowing from inside to outside S₄₋₂ isolates suspicious traffics flowing from inside to outside of a network as shown in FIG. 27. Such a step of isolating traffics flowing from inside to outside includes the steps of performing a first filtering S₄₋₂₋₁ and performing a second filtering S₄₋₂₋₂.

The step of performing a first filtering S₄₋₂₋₁ isolates communication traffics headed for the C&C IP as shown in FIG. 28. In this case, the traffics are dropped if the source SRC IP is a known zombie IP, and the second filtering is performed if the SRC IP is an unknown IP. In addition, communication traffics headed for the zombie IP are isolated as shown in FIG. 29. In this case, if the SRC IP is an unknown IP, the second filtering is performed.

If the SRC IP is an unknown IP in the communication traffics headed for the C&C IP or the zombie IP, the step of performing a second filtering S₄₋₂₋₂ obtains information on a new botnet using L2/L3/L4 information, the number of packets flowing in per unit time PPS, the number of bandwidths per unit time BPS, and the payload size of a corresponding traffic, obtains the SRC IP as a zombie IP, obtains the SRC IP as a C&C IP, and isolates the traffic or notifies the obtained information to a manager so as to cope with the malicious traffic.

As described above, the present invention may provide a malicious traffic isolation method using botnet information, which can accommodate traffics received from a PC or a C&C server infected with a bot into a quarantine area, isolate normal traffics from traffics transmitted from malicious bots, and block the malicious traffics. In addition, the present invention may provide a malicious traffic isolation method using botnet information, which can provide statistics data on isolated botnet traffics and provide selected traffic contents. In addition, the present invention may provide a malicious traffic isolation method using botnet information, which can provide a variety of filtering functions (e.g., filtering based on host and C&C IP, payload size, rate-limit, or rate filtering) in association with the botnet detection system. In addition, the present invention may provide a malicious traffic isolation method using botnet information, which can provide a function of mitigating DDoS attacks of a botnet.

The present invention may provide a malicious traffic isolation system and method using botnet information, which can accommodate traffics received from a PC or a C&C server infected with a bot into a quarantine area, isolate traffics generated by normal users from traffics transmitted from malicious bots, and block the malicious traffics.

Furthermore, the present invention may provide a malicious traffic isolation system and method using botnet information, which can provide a variety of filtering functions (e.g., filtering based on host and C&C IP, payload size, rate-limit, or rate filtering) in association with the botnet detection system.

Furthermore, the present invention may provide a malicious traffic isolation system and method using botnet information, which can provide a function of mitigating DDoS attacks of a botnet.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A malicious traffic isolation system comprising:
a botnet detection system for collecting traffics in a network and detecting a botnet; and
a botnet isolation system for isolating traffics of the botnet.

2. The malicious traffic isolation system according to claim 1, wherein the botnet isolation system comprises:
an isolation system manager for transmitting botnet group information including a protect target list, a zombie IP and C&C IP list;
an isolation system agent for isolating a botnet group based on the botnet group information transmitted from the isolation system manager; and
an isolation system monitor for monitoring the botnet isolation system in real-time.

3. The malicious traffic isolation system according to claim 2, wherein the isolation system agent comprises:
an isolation system agent transmit and receive unit for receiving the protect target list, the zombie IP and C&C IP list from the isolation system manager and transmitting suspicious traffics and information on blockage of the suspicious traffics;
a BGP unit for receiving traffics from the isolation system agent transmit and receive unit;
an IP table unit for controlling filtering of traffics flowing in from the BGP unit; and
a suspicious botnet storage unit for temporarily storing the suspicious traffics and transmitting the suspicious traffics to the isolation system agent transmit and receive unit.

4. A malicious traffic isolation method comprising the steps of:
detecting a botnet in a network; and
isolating traffics of the botnet.

5. The malicious traffic isolation method according to claim 4, further comprising the steps of:
after the step of detecting a botnet in a network,
finding a malicious behavior of the detected botnet; and
receiving existence of the malicious behavior, routing malicious traffics, and setting routing information to examine the malicious traffics.

6. The malicious traffic isolation method according to claim 4, wherein the step of isolating traffics of the botnet comprises the steps of:
isolating traffics of a botnet group flowing from outside to inside of a network in which the botnet is desired to be detected; or
isolating traffics of a botnet group flowing from inside to outside of a network in which the botnet is desired to be detected.

7. The malicious traffic isolation method according to claim 6, wherein the step of isolating traffics of a botnet group flowing from outside to inside of a network in which the botnet is desired to be detected comprises the steps of:
performing a first filtering by isolating DDoS traffics starting from a zombie IP among traffics headed for a safety zone from communication traffics starting from a C&C IP;
performing a second filtering by secondarily determining the DDoS traffics by verifying a botnet IP and similarity using L2/L3/L4 information, the number of packets flowing in per unit time PPS, the number of bandwidths per unit time BPS, and the payload size in order to cope with the botnet traffics; and
if a large amount of traffics flow in from outside to inside of the network after the first and second filtering steps are performed, performing a third filtering by applying rate-limit.

8. The malicious traffic isolation method according to claim 7, wherein in the step of performing the first filtering, communication traffics starting from the zombie IP among the traffics headed for the C&C IP is isolated from traffics starting from an unknown IP.

9. The malicious traffic isolation method according to claim 6, wherein the step of isolating traffics of a botnet group flowing from inside to outside of a network in which the botnet is desired to be detected comprises the steps of:
performing a first filtering by isolating communication traffics headed for a C&C IP, wherein the traffics are dropped if a SRC IP is a known zombie IP, and isolating communication traffics headed for the zombie IP; and
if the SRC IP is an unknown IP in the communication traffics headed for the C&C IP or communication traffics headed for the zombie IP in the step of performing a first filtering, obtaining information on a new botnet using L2/L3/L4 information, the number of packets flowing in per unit time PPS, the number of bandwidths per unit time BPS, and the payload size of a corresponding traffic, obtaining the SRC IP as a zombie IP or the SRC IP as a C&C IP, and isolating the traffics or notifying the obtained information to a manager so as to cope with the malicious traffics.
